(19) United States
(12) Patent Application Publication
(10) Pub. No.: US 2019/0285215 A1
(43) Pub. Date: Sep. 19, 2019

(54) CONNECTOR THAT DISCONNECTS BY PULLING ON A RING

(71) Applicant: A RAYMOND ET CIE, Grenoble (FR)

(72) Inventors: Sofien HAMADENE, Saint Etienne de Crossey (FR); Mathias HAMADENE, Saint Egreve (FR)

(73) Assignee: A RAYMOND ET CIE, Grenoble (FR)

(21) Appl. No.: 16/300,527

(22) PCT Filed: Apr. 20, 2017
(86) PCT No.: PCT/FR2017/050941

§ 371 Date: Nov. 9, 2018

(30) Foreign Application Priority Data
May 11, 2016 (FR) 1654186

(51) Int. Cl. F16L 37/098

(52) U.S. Cl. CPC F16L 37/0982; F16L 37/0985

(57) ABSTRACT

A tubular coupling is provided. The tubular coupling has a female endpiece with an axial orifice into which a male endpiece provided with a collar is designed to be inserted axially. The female endpiece includes a latching locking member that is designed to be deformed elastically in a radial direction by mechanical interference during insertion of the male endpiece into the orifice and to become locked against the back of the collar. The coupling further includes a ring mounted to slide coaxially with the orifice around the female endpiece and that forms a ramp that is oblique relative to the axial direction in order to deform the locking member elastically in a radial direction by the lever effect when the ring is subjected to axial traction in the direction for inserting the male endpiece into the female endpiece so as to release the male endpiece from the female endpiece.

### CROSS REFERENCE TO RELATED APPLICATIONS

The present application is a 371 national phase entry of PCT/FR2017/050941, filed on 20 Apr. 2017, which claims the priority of FR Patent Application No. 1654186, filed on 11 May 2016, the contents of which are incorporated herein by reference in their entirety.

### TECHNICAL FIELD

The present invention relates to the field of tubular couplings in the automobile industry for connecting together two fluid transport pipes, and in particular for connecting the fuel injector, the filter, the radiator, or any other appropriate piece of equipment, and/or in any other similar technical field.

More particularly, the invention provides a tubular coupling comprising a female endpiece presenting a tubular hollow body that extends along an axial direction and that forms an axial orifice into which a male endpiece provided with a collar is designed to be inserted axially, the hollow body of the female endpiece including a latching locking member that extends axially along the hollow body and that is designed to be deformed elastically in a radial direction by mechanical interference with the collar during the insertion of the male endpiece into the orifice of the female endpiece and to become locked against the back of the collar when the male endpiece is pushed fully into the orifice of the female endpiece.

### RELATED ART

Such a tubular coupling for connecting together air conditioning or power steering circuits in a motor vehicle is already known, in particular from patent document FR 2 944 084.

In that known tubular coupling, a locking ring for connecting together male and female endpieces is mounted around the body of the female endpiece and is suitable for reversibly locking latches of the female endpiece against a collar of the male endpiece. In that coupling, the latches of the female endpiece are arranged on the free ends of flexible fingers, the fingers also passing axially through the ring via openings arranged in the circumference of the ring. Furthermore, in that coupling, the ring includes a holder tab for attaching to the collar of the male endpiece.

That known tubular coupling nevertheless presents several drawbacks. Firstly, the structure of the flexible fingers of the female endpiece together with the ring is complex and the coupling does not appear to be compact. Furthermore, in that coupling, in order to connect the two endpieces together, after axially engaging the male endpiece in the female endpiece, in addition to manually sliding the ring axially in order to become arranged radially around the fingers so as to block the latches against the collar, it is necessary to perform additional locking by attaching the holder tab of the ring by manually tilting it against the collar. Conversely, in order to disconnect the two endpieces it is necessary to begin by manually tilting the holder tab of the ring so as to disengage it from the collar, and then manually to cause the ring to slide axially in the direction for inserting the male endpiece so that the fingers splay apart sufficiently to release the collar.

As a result, the act of connecting together and disconnecting the two endpieces both involve a plurality of manual steps, which can be laborious for operators and can lengthen the times required for assembly or disassembly.

Document EP 1 561 064 also relates to a tubular quick coupling having a female endpiece presenting a hollow body defining an orifice into which a male endpiece is inserted axially. On the outside of the body there are arranged to two resilient snap-fastening branches extending axially and each carrying at one of its ends a latch for latching the female endpiece on a collar of the male endpiece. Each of the branches is connected to the body via a tilting point by means of a hinge in the form of a spacer. In order to snap-fasten the collar of the male endpiece, the latches need to be spread apart by pressing on the other ends of the branches. In that device, in order to limit the overall size of the coupling, the hinge is of small thickness. As a result, under the effect of temperature and/or of fluid pressure, both of which may be high in the coupling, the coupling can become deformed, in particular at its hinges. That deformation can make it difficult or even impossible to undo the coupling, and indeed, if the deformation is excessive, leaks can be caused. Thus, the use of resilient branches connected via hinges at the periphery of the hollow body of a female endpiece for the purpose of snap-fastening with a male endpiece is not very suitable for certain utilizations in the automobile industry.

Documents US 2012/319401 and DE 296 10 487 also relate to tubular couplings.

### SUMMARY OF THE INVENTION

The object of the invention is thus to mitigate the above-mentioned drawbacks.

To this end, the invention provides a tubular coupling comprising a female endpiece presenting a tubular hollow body that extends along an axial direction and that forms an axial orifice into which a male endpiece provided with a collar is designed to be inserted axially, the hollow body of the female endpiece including a latching locking member that extends axially along the hollow body and that is designed to be deformed elastically in a radial direction by mechanical interference with the collar during the insertion of the male endpiece into the orifice of the female endpiece and to become locked against the back of the collar when the male endpiece is pushed fully into the orifice of the female endpiece, the tubular coupling being characterized in that it further comprises a ring mounted to slide coaxially with the orifice around the female endpiece and that forms a ramp that is oblique relative to the axial direction and that is inclined radially towards the outside of the hollow body in order to deform the locking member elastically in a radial direction by the lever effect when the ring is subjected to axial traction in the direction for inserting the male endpiece into the female endpiece so as to release the male endpiece from the female endpiece.

The coupling of the invention may present the following features:
the locking member may comprise two latching fingers that are distributed around the orifice of the female endpiece, each latching finger including two lateral shoulders, and in that the ring may form, for each latching finger, two parallel oblique ramps against which the two lateral shoulders of the latching finger bear respectively;
the ring may have two lateral openings distributed around the circumference of the ring, each bordered by each two parallel ramps;
the two parallel ramps may be joined together by a web of reinforcing material;
the two lateral shoulders of a latching finger may form portions of a lateral rib that slide axially in the groove of the ring;
the ring may be held around the female endpiece by clips; and
the ring may include respective radially projecting ribs at the lateral openings, each rib being arranged to hold the ring around the female endpiece.

The idea on which the invention is based is to be able to couple together and to disconnect a male endpiece and a female endpiece quickly and easily using a tubular coupling that is easy to use and that is made up of two main parts.

With the arrangement of the invention, the male endpiece couples automatically in the coupling merely by snap-fastening as a result of being inserted axially into the orifice of the female endpiece. The male endpiece is disconnected from the coupling in simple manner by pulling the coupling while pulling axially on a sliding ring that surrounds the female endpiece.

Furthermore, with the arrangement of the invention, it is possible to assemble the tubular coupling easily, with the ring sliding in controlled manner along the female endpiece. The tubular coupling of the invention is compact, and with such a structure the risks of deformation that might arise as a result of high temperatures and/or pressure are reduced.

Other characteristics, advantages, and details of the present invention appear on reading the following description of an embodiment of the invention given by way of non-limiting illustration, the description being made with reference to the drawings listed below.

### BRIEF DESCRIPTION OF THE DRAWINGS

The present invention can be better understood and other advantages appear on reading the following description and the accompanying drawings, in which:

FIG. 1 is a diagrammatic exploded perspective view showing the tubular coupling in a first embodiment of the invention with the female endpiece, the ring, and the male endpiece;

FIG. 2 is a diagrammatic perspective view with sections of two planes showing the FIG. 1 tubular coupling with the ring mounted on the female endpiece;

FIG. 3 is a perspective view of the tubular coupling of the invention in a pre-coupling position on the male endpiece;

FIGS. 4A and 4B are respectively a profile view and a cross-section view of the tubular coupling of the invention in a coupled state with the male endpiece;

FIGS. 5A and 5B are respectively a profile view and a cross-section view of the tubular coupling of the invention in an intermediate disconnection state with the male endpiece;

FIG. 6 is a perspective view showing a tubular coupling in a second embodiment of the invention with the ring mounted on the female endpiece;

FIG. 7 is a perspective view of the ring of the tubular coupling in the second embodiment; and

FIG. 8 is a diagrammatic view in cross-section and in perspective shown the FIG. 6 tubular coupling with the ring mounted on the female endpiece.

### DETAILED DESCRIPTION OF EXAMPLE EMBODIMENTS

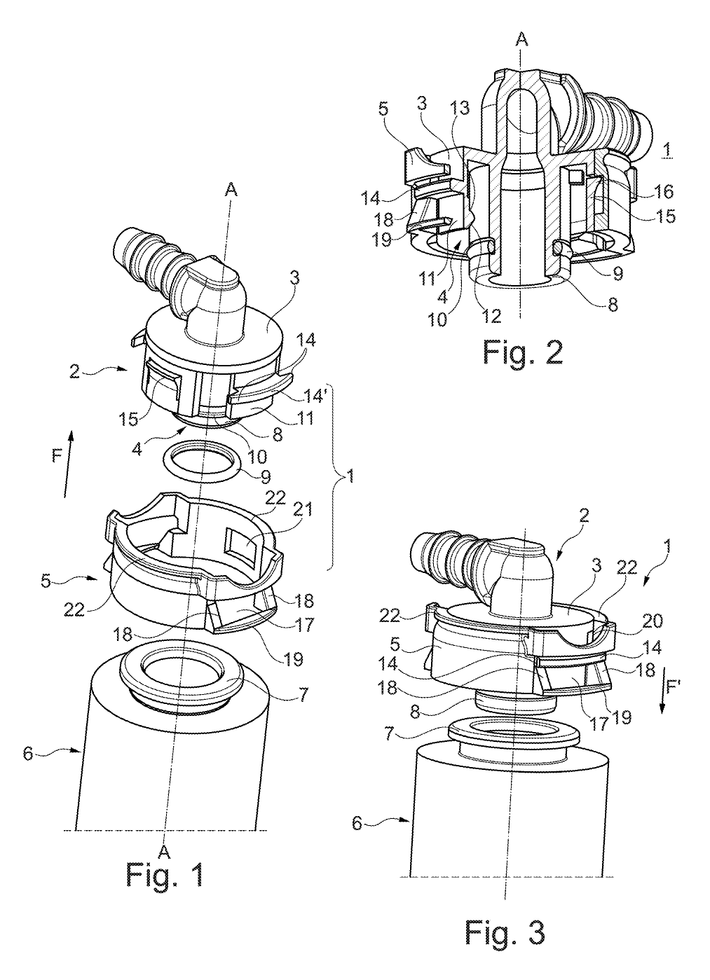

FIG. 1 is an exploded view showing the various portions of a tubular coupling 1 in a first embodiment of the invention.

In this example, the tubular coupling 1 comprises a female tubular connection endpiece (female endpiece) 2 having a bend, comprising a main hollow body 3 of tubular shape that extends along an axial direction A and that presents an axial orifice 4.

FIG. 1 shows a ring 5 that can be engaged coaxially with the orifice 4 around the body 3 (along arrow F), and FIG. 2 shows the ring 5 engaged on the body 3 of the female endpiece 2 of the tubular coupling 1.

FIG. 1 shows a male tubular connection endpiece (male endpiece) 6 that is for inserting axially in the orifice 4 of the female endpiece 2.

In this example, the male endpiece 6 is in the form of a base of elongate cylindrical shape and it presents at its free end a radial coupling abutment formed by a collar 7, the diameter of the collar 7 being a little less than the inside diameter of the orifice 4.

As can also be seen in FIGS. 1 and 2, in this example, a duct 8 extends axially inside the hollow body 3, via which a fluid can flow.

The outside diameter of the duct 8 is determined relative to the inside diameter of the collar 7 so that during axial insertion of the male endpiece 6 into the body 3 of the female endpiece 2, the collar 7 in this example is received in the orifice 4 between the body 3 of the female endpiece 2 and the duct 8.

Sealing between the female and male endpieces 2 and 6 may be provided in part by a gasket 9 that is received in an annular outside groove 10 of the duct 8, as can be seen in FIG. 2.

In the invention, the female element 2 has at least one locking member in the form of a latching flexible finger 11 that extends in the axial direction A and that is designed to deform elastically radially towards the outside of the body 3 of the female endpiece 2 under the effect of mechanical interference with the collar 7 when the male endpiece 6 is inserted in the orifice 4 of the female endpiece 2.

The tubular body 3 may include a plurality of locking members 11 distributed around the circumference of the body 3.

In this example, the tubular body 3 has two latching fingers 11 that are diametrically opposite relative to the orifice 4, each of which is defined by two axial slots in the body 3, which go as far as the edge of the orifice 4.

Each latching finger 11 presents a free end forming a radially sloping inside rib 12, that can be seen clearly in FIG. 2.

On axial insertion of the male endpiece 6 into the orifice 4 of the female endpiece 2, the front face of the collar 7 (in the direction the male endpiece 6 is inserted into the body 3) presses against the rib 12 so as to move the finger 11 away radially and allow the collar 7 to pass into the hollow body 3.

The rib 12 also presents a barbed latch 13 that, in known manner, once the finger 11 has returned elastically, comes into contact against the back face of the collar 7 so as to block the male endpiece 6 axially in a fully engaged coupling position in the orifice 4 of the female endpiece 2 of the tubular coupling 1.

In the invention, each latching finger 11 presents at least one lateral shoulder 14 projecting radially relative to the external circumference of the hollow body 3. In this example, two lateral shoulders 14 are shown, and they are connected together by material so as to form a lateral rib 14′ that projects radially towards the outside of the body 3. Each shoulder 14 is for co-operating with a ramp 18 present on the ring 5, as described below.

In the first embodiment of the invention, the hollow body 3 may also include at least one flexible clip 15 designed to deform elastically radially towards the inside of the body 3 by mechanical interference with the ring 5 when it is engaged axially around the body 3.

In this example, two flexible clips 15 are diametrically opposite, each being arranged on either side of a latching finger 11, or being positioned between two latching fingers 11.

The flexible clips 15 extend axially along the body 3 and they are oriented in the opposite direction to the latching fingers 11. Each clip 15 has a free end that projects radially towards the outside of the body 3, forming a retaining latch 16 for holding the ring 5 slidably around the body 3, as explained below.

In its peripheral outline, the ring 5 has a lateral opening 17 that is axially defined on its sides by respective oblique ramps 18 that are inclined radially towards the outside with a slope that is oriented in the direction opposite to the direction for inserting the male endpiece 6. In this example, two lateral openings 17 are distributed around the peripheral outline of the ring 5, e.g. being diametrically opposite, and each of them is bounded by two parallel ramps 18.

The oblique ramps 18 defining a lateral opening 17 may be joined together by a web 19 of material so as to reinforce the structure of the ring 5.

Optionally, the ring may include grooves 20 arranged axially above the ramps 18 and in which the shoulders 14 slide axially while the ring 5 is being engaged axially around the body 3 of the female endpiece 2, the grooves 20 acting as guides for the engagement.

In the invention, the ring 5 may also include blocking means 21 arranged in the periphery of the ring 5 and interacting with the flexible clip 15 arranged on the body 3 of the female endpiece 2.

In a first variant of the first embodiment, the blocking means 21 comprise a recess forming a kind of groove arranged in the internal periphery of the ring 5. The height of the groove is selected so that overall it is equivalent to the height of the flexible clip 15 so as to allow the ring 5 to slide axially along the body 3 over the height of the groove.

In a second variant of the first embodiment that is not shown, the blocking means 21 may comprise a window of height that is likewise equivalent overall to the height of the flexible clip 15 so as to allow the ring 5 to slide axially along the body 3 over the height of the window.

In the invention, the ring 5 also presents grip means 22 on the outside periphery, which means may for example project radially so as to be gripped by an operator so as to make it easier to exert axial traction on the ring 5.

Prior to using the tubular coupling 1, the ring 5 needs to engaged axially around the body 3 of the female endpiece 2 along arrow F. For this purpose, the ring 5 is positioned as shown in FIG. 1, i.e. the lateral openings 17 in the ring 5 are in register with the flexible latching fingers 11 of the female endpiece 2, and the blocking means 21 of the ring 5 are in register with the flexible clip 15 of the female endpiece 2.

In the first embodiment, during axial engagement of the ring 5 around the body 3, the top surface of the ring 5 presses against the projecting flexible clips 15. They are thus retraced elastically towards the inside of the body 3 so as to allow the top portion of the ring 5 to pass around the body 3. Thereafter, the clips 15 deploy into the recess or the window acting as blocking means 21. During the engagement of the ring around the body, the shoulders 14 can slide axially in the grooves 20 of the ring that are optionally arranged above the ramps 18. The grooves 20 thus provide indexing means to ensure that the ring 5 and the body 3 are properly oriented relative to each other during engagement.

In the invention, in this engagement position, the ring 5 can slide axially along the body 3.

Nevertheless, such axial sliding is limited in that the projecting retaining latch 16 comes into abutment against one or the other of the longitudinal sides of the recess or of the window. As mentioned above, the ring 5 can slide axially only over the height of the blocking means 21.

In order to better understand the invention better, the steps of coupling the male endpiece 6 in the female endpiece 2, and of uncoupling them, as shown in FIGS. 3 to 5 are described briefly below.

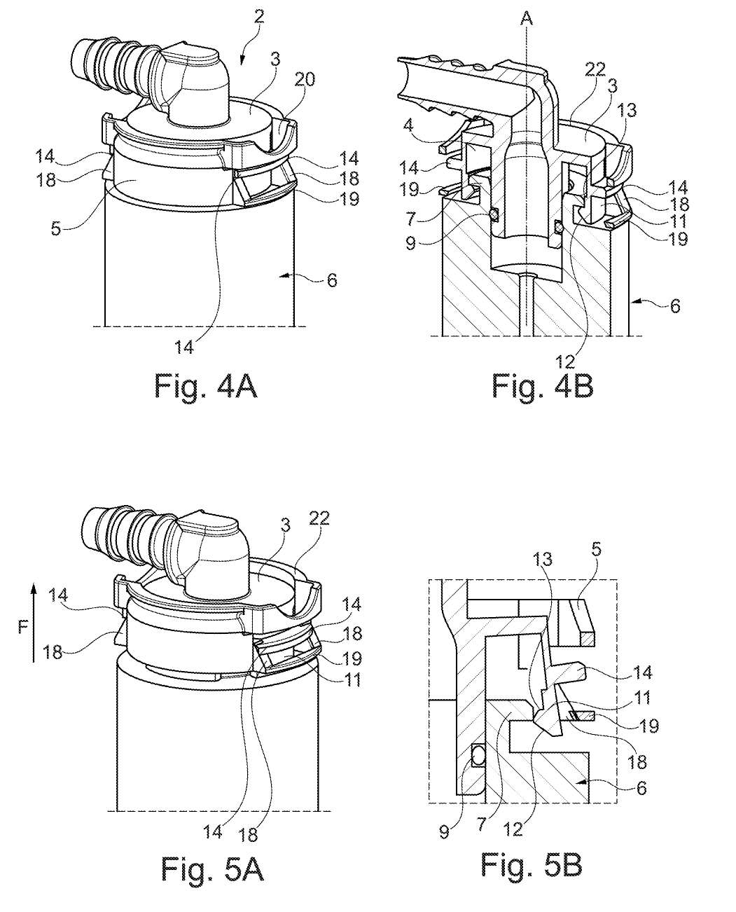

In order to couple the male endpiece 6 with the female endpiece 2, the male endpiece 6 is pushed axially into the orifice 4 of the tubular coupling 1 along arrow F′ shown in FIG. 3. As mentioned above, the collar 7 comes to bear against the inclined ribs 12 of the latching fingers 11 in order to spread the fingers 11 elastically radially towards the outside of the body 3, thereby allowing the collar 7 to pass. After the collar 7 has gone beyond the ribs 12, the fingers 11 return elastically and the barbed latches 13 block the collar 7 axially. The male endpiece 6 pushed fully into the orifice 4 of the female endpiece 2 is then in a coupling position in the tubular coupling 1. The coupling position is shown in FIGS. 4A and 4B. In FIG. 4A, it can clearly be seen that in this position each of the shoulders 14 of the body 3 of the female endpiece 2 presses against the low point of an oblique ramp 18 of the ring 5. In the invention, and as can be seen in FIGS. 4A and 4B, it is advantageous to have a tubular coupling 1 that does not exceed the diameter of the base of the male endpiece 6. The tubular coupling 1 of the invention is thus compact.

Thereafter, in order to disconnect the male endpiece 6 from the tubular coupling 1, as shown in FIGS. 5A and 5B, an operator uses one hand to hold the male endpiece 6 and uses the other hand to grip the grip means 22 of the ring 5. By pulling the grip means 22 axially along arrow F, the ring 5 is caused to slide axially along the body 3, with the shoulders 14 then sliding over the oblique ramps 18 so that the shoulders 14 move radially towards the outside of the body 3. By the lever effect, the latching fingers 11 also move radially towards the outside of the body 3, as can be seen in FIG. 5B, until they are spaced apart sufficiently for the barbed latches 13 no longer to be in contact with the collar 7. By pulling the ring 5 in the insertion direction of the male endpiece 6, the collar 7 is thus released from the barbed latches 13 of the fingers 11, thereby disconnecting the male endpiece 6 from the tubular coupling 1.

It should be observed that after the endpieces 2 and 6 have been disconnected, the shoulders 14 return elastically to the low point of the oblique ramps 18, with the latching fingers 11 moving inverse. The ring 5 thus returns automatically to its initial position, as shown in FIG. 2.

Thus, in the invention, the male endpiece 6 is connected to the tubular coupling 1 in the orifice 4 of the female endpiece 2 by simple axial insertion, and the endpieces 2 and 6 are disconnected simply by pulling axially on the ring 5.

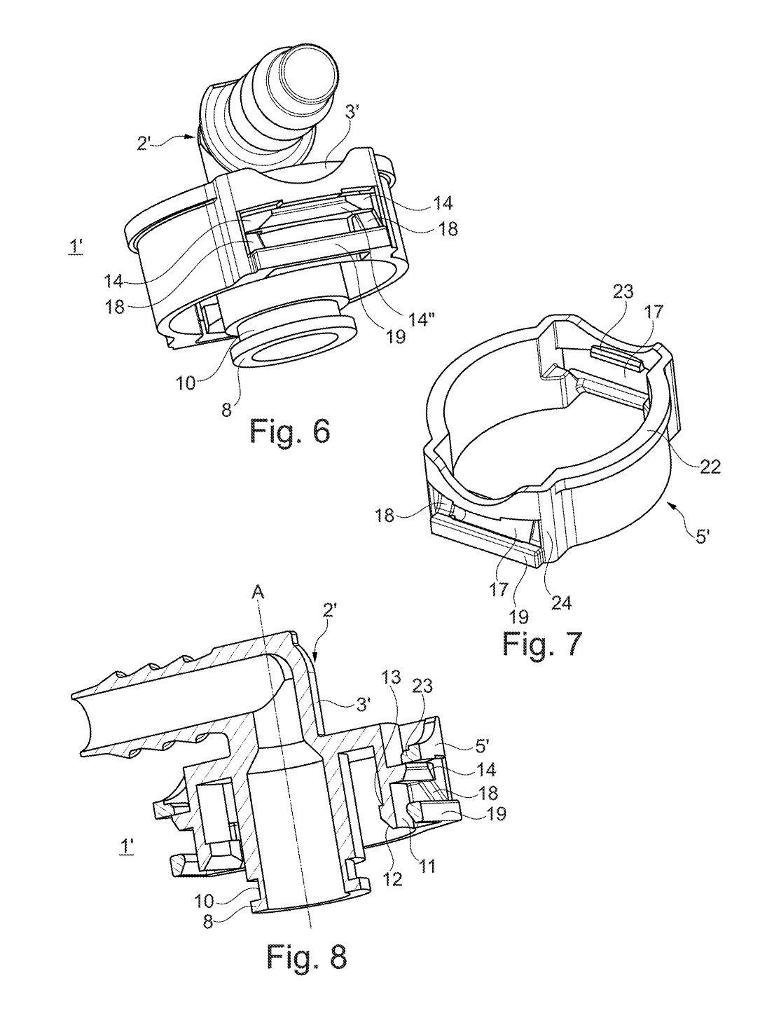

FIGS. 6 to 8 show a tubular endpiece 1′ in a second embodiment, having a ring 5′ mounted on a female endpiece 2′.

Below, it should be understood that elements that are common to both tubular couplings 1 and 1′ in the two embodiments are given the same references.

The tubular endpiece 1′ differs from the tubular coupling 1 mainly in that the female endpiece 2′ does not have a flexible clip and the ring 5′ does not have blocking means. Thus, in the invention, the tubular coupling 1′ is a structure that is even simpler than in the prior art.

In the invention, the female endpiece 2′ has a flexible finger 11′ that performs two functions, the first being as is the first embodiment to allow the male endpiece 6 to be disconnected from the tubular coupling 1′ by pulling axially on the ring 5′, the second being a clip-fastening function during axial engagement of the ring 5′ around the body 3′ of the female endpiece 2′.

The flexible finger 11′ presents a groove 14″ connecting together the two shoulders 14, which groove is oblique, being inclined radially towards the inside.

The lateral opening 17 in the ring 5′ in this example is defined on top, in the engagement direction of the ring 5′ by a radially projecting groove 23 that is oblique, sloping radially towards the outside.

This example shows a body 3′ with two flexible fingers 11′ distributed around the body 3′ and a ring 5′ with two lateral openings 17 distributed around the periphery so that during engagement of the ring 5′ around the body 3′ of the female endpiece 2′, the flexible fingers 11′ are in register with the lateral openings 17.

Thus, during axial engagement of the ring 5′ around the body 3′, the inclined grooves 23 of the ring 5′ come into contact with the inclined grooves 14″ of the fingers 11 and press against the grooves 14″ of the flexible fingers 11′. The fingers then retract elastically towards the inside of the body 3′ so as to allow the top portion of the ring 5′ to pass with the grooves 23 around the body 3′. Thereafter, the fingers 11′ become deployed elastically into the lateral opening 17′ of the ring 5′ so that the shoulders 14 are positioned at the low points of the oblique ramps 18. In this second embodiment, in the lateral openings 17′, the ramps 18 are protected by margins 24 extending axially outside the ring 5′. Advantageously, these margins protect the fingers 11′ from impacts that might occur against the tubular endpiece 1′.

In the invention, the tubular coupling 1, 1′ is compact and presents a structure of less complexity than existing couplings.

Advantageously, the ring 5, 5′ surrounding the female endpiece 2, 2′ serves to protect the tubular endpiece 1, 1′ from potential infiltration of dust or other materials into the orifices 4 of the bodies 3, 3′.

The elements of the tubular coupling 1 of the invention, i.e. the female endpiece 2, 2′ and the ring 5, 5′ may be made of plastics material, e.g. by injection molding or by 3D printing.

In the invention, as described above, in the tubular coupling 1, 1′, since the ring 5, 5′ does not have any element that requires flexibility, the female endpiece 2, 2′ presents in particular the latching fingers 11 as flexible elements. It is thus possible to envisage fabricating the ring 5, 5′ and the female endpiece 1, 1′ out of two different materials, in particular it is advantageous to select a material of greater hardness for the ring 5, 5′ than for the female endpiece 2, 2′. Thus, in the event of temperature or pressure rising in the tubular coupling 1, 1′, the ring 5, 5′ surrounding the body 3, 3′ of the female endpiece 2, 2′ can limit any risk of deformation.

Naturally, the present invention is not limited in any way to the above description of an implementation thereof, and it may be subjected to modifications without going beyond the ambit of the invention.

1. A tubular coupling, comprising: a female endpiece presenting a tubular hollow body that extends along an axial direction and that forms an axial orifice into which a male endpiece provided with a collar is designed to be inserted axially, said hollow body of said female endpiece includes a latching locking member that extends axially along said hollow body and that is designed to be deformed elastically in a radial direction by mechanical interference with said collar during said insertion of said male endpiece into said orifice of said female endpiece and to become locked against the back of said collar when said male endpiece is pushed fully into said orifice of said female endpiece, a ring mounted to slide coaxially with said orifice around said female endpiece and that forms a ramp that is oblique relative to the axial direction and that is inclined radially towards the outside of said hollow body in order to deform said locking member elastically in a radial direction by the lever effect when said ring is subjected to axial traction in the direction for inserting said male endpiece into said female endpiece so as to release said male endpiece from said female endpiece.

2. A tubular coupling according to claim 1, wherein said locking member comprises two latching fingers that are distributed around said orifice of said female endpiece, each latching finger including two lateral shoulders, and said ring forms, for each latching finger, two parallel oblique ramps against which said two lateral shoulders of the latching finger bear respectively.

3. A tubular coupling according to claim 2, wherein said ring has two lateral openings distributed around the peripheral outline of said ring, each bordered by each two parallel ramps.

4. A tubular coupling according to claim 3, wherein said two parallel ramps are joined together by a web of reinforcing material.

5. A tubular coupling according to claim 2, wherein said two lateral shoulders of a latching finger form portions of a lateral rib that slide axially in the groove of said ring.

6. A tubular coupling according to claim 1, wherein said ring is held around said female endpiece by clips.

7. A tubular coupling according to claim 3, wherein said ring includes respective radially projecting ribs at the lateral openings, each rib being arranged to hold said ring around said female endpiece.
